(19) United States
(12) Patent Application Publication
(10) Pub. No.: US 2009/0189863 A1
(43) Pub. Date: Jul. 30, 2009

(54) COMBINATION CONSOLE MODULE FOR KVM SWITCH

(75) Inventor: Yi-Li Liu, DELTA (CA)

Correspondence Address: YING CHEN;Chen Yoshimura LLP, 255 S. GRAND AVE., # 215, LOS ANGELES, CA, 90012, US

(73) Assignee: ATEN INTERNATIONAL CO., LTD., Taipei (TW)

(21) Appl. No.: 12/020,654

(22) Filed: Jan. 28, 2008

(51) Int. Cl. G06F 3/02

(52) U.S. Cl. 345/168

(57) ABSTRACT

A combination console module is described which enables a console to be used both as a local console for a local KVM switch and as a remote console for a remote network-enabled KVM (IKVM) switch. In a stand-alone configuration, the combination console module includes a control section, an analog-to-digital converter for converting analog video signals from the KVM switch to digital video signals, a digital-to-analog converter (DAC) for converting digital video signals from the network to analog signals, a video switch for applying either the input video signal form the KVM switch or video signals from the DAC to the console's display, and a network interface device. The keyboard/mouse signals from the console are processed by the control section and transmitted to either the KVM switch or the network. The combination console module can also be implemented by modifying a conventional IKVM switch by adding the DAC.

### BACKGROUND OF THE INVENTION

1. Field of the Invention

This invention relates to a console module for a KVM (keyboard-video-mouse) switch, and in particular, it relates to a console module that can act as both a local console for a local KVM switch or a local IP-based KVM switch and a remote console for a remote IP-based KVM switch.

2. Description of the Related Art

In a conventional KVM switch configuration, one or more consoles (each including a keyboard and/or mouse and a display device) are connected to the KVM switch by cables, and a plurality of computers (e.g. servers or PCs) are connected to the KVM switch by cables. The cables are from a few feet (e.g. PS2 cables) to hundreds of feet (e.g. CAT 5 cables) long. A network-enabled KVM switch (sometimes referred to as an IP-based KVM switch or an IKVM switch, and the technology is sometimes referred to KVM over IP) uses a network protocol (e.g. TCP/IP) as its communication protocol, and can be accessed from any computer on a network such as a WAN, LAN or the Internet. A remote operator can log in to an IKVM switch from anywhere on the network via their browser. Once logged in, the operator can exchange keyboard, video and mouse signals with any one of the computers connected to the IKVM switch. Similar to conventional KVM switches, an IKVM switch typically also have one or more local consoles connected to it by cables.

In conventional KVM or IKVM switch configurations, a conventional console that is used as a local console for a KVM or IKVM switch is connected to the switch by cables; it transmits analog keyboard/mouse signals to the switch and receives analog video signals from the switch. Such a conventional local console lacks a network interface. On the other hand, a conventional console that is used as a remote console for an IKVM switch has a network interface for connecting to a network; keyboard and mouse signals are transmitted as digital signals over the network to the IKVM switch, and video signals from the IKVM switch are received as digital signals over the network. The video signals from the IKVM switch are decompressed and displayed on the display device of the console. Such a conventional remote console typically can only communicate over the network and cannot be connected to a KVM switch by cable and used as a local console. In other words, a conventional local console connected to a KVM switch/IKVM switch cannot be used as a remote console connected to another IKVM switch, and a conventional remote console connected to a KVM switch/IKVM switch cannot be used as a local console connected to another IKVM switch.

### SUMMARY OF THE INVENTION

The present invention is directed to a combination console module that substantially obviates one or more of the problems due to limitations and disadvantages of the related art.

An object of the present invention is to provide a combination console module that allows a console to function both as a local console to access computers connected to a local KVM switch or a local IKVM switch and as a remote console to access computers connected to a remote IKVM switch.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, the present invention provides a control device for connecting to a console, the console including one or more input devices and a display device, the control device including: a control section; an input connection for connecting to the input devices of the console, the input connection being connected to the control section; a video connection for connecting to the display device of the console; a video signal converter connected between the control section and the video connection for converting a processed digital video signal from the control section to a display video signal for the display device; a video switch connected to the video signal converter and connected to an input video signal, the video switch being controlled by the control section for providing either the input video signal or the display video signal to the video connection; and a network interface device for connecting to a network, wherein when the control device is in a local mode, the video switch switches the input video signal to the video connection, and the control section processes a first input device signal received from the console via the input connection to generated a processed input device signal, and wherein when the control device is in a remote mode, the control section processes a digital video signal received from the network via the network interface device to generate the processed digital video signal, the video signal converter converts the processed digital video signal to the display video signal, the video switch switches the display video signal from the video signal converter to the video connection, and the control section processes the input device signal received from the console via the input connection and transmit it to the network via the network interface device.

In another aspect, the present invention provides a method implemented in a control device, the control device adapted to be connected to a console and to a network, the method including: (a) selecting a local mode or a remote mode; when in the local mode, (b1) processing a local input video signal and transmitting the processed video signal to the console; and (b2) processing a first input device signal received from the console and generating a processed input device signal; and when in the remote mode, (c1) processing a digital video signal received from the network and transmitting the processed video signals to the console; and (c2) processing the first input device signal received from the console and transmitting the processed input device signal to the network.

In another aspect, the present invention provides a computer management system, including: a first keyboard-video-mouse (KVM) switch; at least one first computer connected to the first KVM switch; a second KVM switch; at least one second computer connected to the second KVM switch; a first console module connected to the first KVM switch, the first console module being connected to the second KVM switch via a network; and a console connected to the first console module, wherein the first console module allows the console to selectively control the first computer or the second computer.

In another aspect, the present invention provides a console module for connecting a console to a KVM (keyboard-video-mouse) switch, the console including one or more input devices and a display device, the console module including: a control section; an input connection for connecting to the input devices of the console, the input connection being connected to the control section; a video connection for connecting to the display device of the console; a digital to analog converter (DAC) connected to the control section for converting digital video signals to analog video signals; a video switch connected to the DAC and connected to input video signals from the KVM switch, the video switch being controlled by the control section for providing either the input video signals from the KVM switch or the analog video signals from the DAC to the video connection; and a network interface device for connecting to a network; wherein when the console module is in a local mode, the video switch switches the input video signals from the KVM switch to the video connection, and the control section processes input signals received from the console via the input connection and transmit them to the KVM switch, and wherein when the console module is in a remote mode, the control section processes digital video signals received from the network via the network interface device, the DAC converts the processed digital video signal to analog video signals, the video switch switches the analog video signals from the DAC to the video connection, and the control section processes input signals received from the console via the input connection and transmit them to the network via the network interface device.

The console module may further include an analog to digital converter (ADC) for converting the input video signals from the KVM switch to digital video signals, wherein when the console module is in an intermediary mode, the ADC converts the input video signals from the KVM switch to digital video signals, the control section processes the digital video signals and transmits them to the network via the network interface device, and the control section further processes input signals received from the network via the network interface device and transmits them to the KVM switch.

In another aspect, the present invention provides a KVM (keyboard-video-mouse) switch for connecting at least one console to one or more computers, the console including one or more input devices and a display device, the KVM switch including: a switching section having at least one console signal port and one or more computer signal ports, the switching section switching signals between the console signal port and the computer signal ports; a control section connected to the console signal port of the switching section; an input connection for connecting to the input devices of the console, the input connection being connected to the control section; a video connection for connecting to the display device of the console; a digital to analog converter (DAC) connected to the control section for converting digital video signals to analog video signals; a video switch connected to the DAC and connected to video signals from the switching section, the video switch being controlled by the control section for providing either the video signals from the switching section or the analog video signals from the DAC to the video connection; and a network interface device for connecting to a network; wherein when the KVM switch is in a local mode with respect to the console, the video switch switches the video signals from the switching section to the video connection, and the control section processes input signals received from the console via the input connections and transmit them to the switching section, and wherein when the KVM switch is in a remote mode with respect to the console, the control section processes digital video signals received from the network via the network interface device, the DAC converts the processed digital video signal to analog video signals, the video switch switches the analog video signals from the DAC to the video connection, and the control section processes input signals received from the console via the input connections and transmit them to the network via the network interface device.

The KVM switch may further include an analog to digital converter (ADC) connected to the switching section for converting the video signals from the switching section to digital video signals, wherein when the KVM switch communicates with a remote client on the network, the ADC converts the video signals from the switching section to digital video signals, the control section processes the digital video signals and transmits them to the network via the network interface device, and the control section further processes input signals received from the network via the network interface device and transmits them to the switching section.

In another aspect, the present invention provides a method implemented in a console module, the console module adapted to be connected to a console, to a network and to a KVM (keyboard-video-mouse) switch, the method including: (a) selecting a local mode or a remote mode; when in the local mode, (b1) processing video signals received from the KVM switch and transmitting the processed video signals to the console; and (b2) processing input signals received from the console and transmitting the processed signals to the KVM switch; and when in the remote mode, (c1) processing video signals received from the network and transmitting the processed video signals to the console; and (c2) processing input signals received from the console and transmitting the processed signals to the network.

The method may further include: (d) selecting an intermediary mode; when in the intermediary mode, (e1) processing video signals received from the KVM switch and transmitting the processed video signals to the network; and (e2) processing input signals received from the network and transmitting the processed signals to the KVM switch.

In another aspect, the present invention provides a method implemented in a KVM (keyboard-video-mouse) switch, the KVM switch adapted to be connected to at least one console, to a network and to one or more computers, the method including: (a) selecting a local mode or a remote mode with respect to the console; when in the local mode, (b1) processing video signals received from a selected computer and transmitting the processed video signals to the console; and (b2) processing input signals received from the console and transmitting the processed signals to the selected computer; and when in the remote mode, (c1) processing video signals received from the network and transmitting the processed video signals to the console; and (c2) processing input signals received from the console and transmitting the processed signals to the network.

The method may further include: (d) selecting a remote client mode; when in the remote client mode, (e1) processing video signals received from the selected computer and transmitting the processed video signals to the network; and (e2) processing input signals received from the network and transmitting the processed signals to the selected computer.

It is to be understood that both the foregoing general description and the following detailed description are exemplary and explanatory and are intended to provide further explanation of the invention as claimed.

### BRIEF DESCRIPTION OF THE DRAWINGS

FIG. 1 illustrates a system configuration including a stand-alone combination console module according to an embodiment of the present invention.

FIG. 2 illustrates a stand-alone (external) combination console module according to an embodiment of the present invention.

FIG. 3 illustrates a stand-alone (external) combination console module according to another embodiment of the present invention.

FIG. 4 illustrates a stand-alone (external) combination console module according to yet another embodiment of the present invention.

FIG. 5 illustrates another system configuration including a combination console module as a part of a KVM switch/IKVM switch according to an embodiment of the present invention.

FIG. 6 illustrates an IKVM switch including a combination console module function according to an embodiment of the present invention.

### DETAILED DESCRIPTION OF THE PREFERRED EMBODIMENTS

As required, a detailed illustrative embodiment of the present invention is disclosed herein. However, techniques, systems and operating structures in accordance with the present invention may be embodied in a wide variety of forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein, which define the scope of the present invention. The following presents a detailed description of the preferred embodiment (as well as some alternative embodiments) of the present invention.

Embodiments of the present invention provide a combination console module that enables a console to be used both as a local console for a local KVM switch or local IKVM switch, and as a remote console for a remote IKVM switch on a network. The combination console module can be implemented in two configurations, as a stand-alone (i.e. external) module or as a part of a modified IKVM switch.

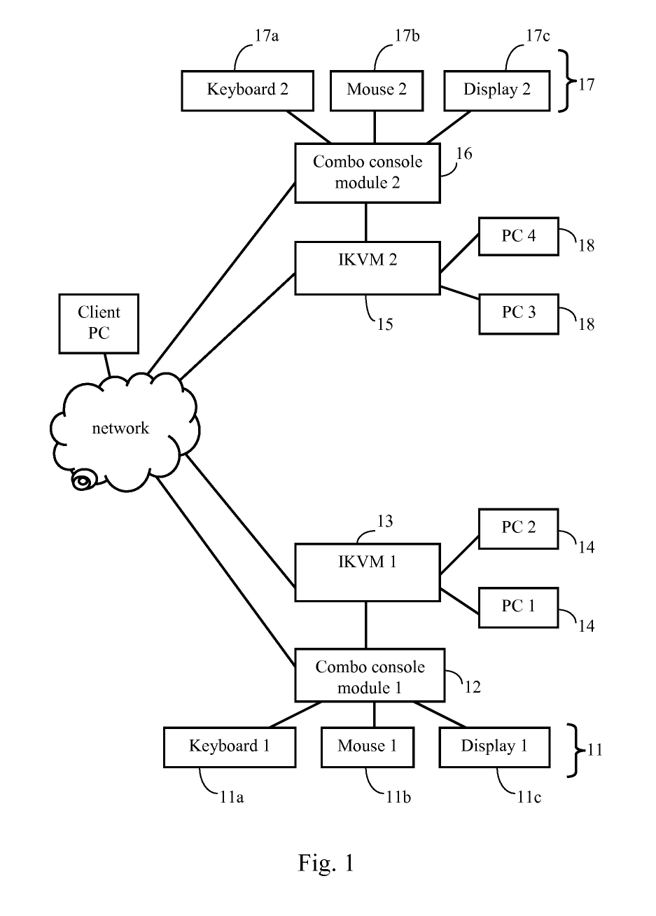

In the first configuration, shown in FIG. 1, a combination console module 12 is provided as a stand-alone/external module that can be connected to a KVM switch or local IKVM switch 13 by cables. (In this disclosure, the term “KVM switch” refers to either a non-IP-based switch or an IP-based switch or both, unless otherwise specified.) The console 11 including a keyboard 11a, a mouse 11b and a display 11c is connected to the combination console module 12 by cables. The stand-alone combination console module 12 has both a network interface for connecting to a network to exchange digital keyboard/mouse and video signals with a remote IKVM switch 15, and analog connections for exchanging analog keyboard/mouse and video signals with the local KVM switch 13. A plurality of local computers 14 are connected to the local KVM switch 13. The local KVM switch 13 shown in FIG. 1 is an IP-based switch and is connected to the network, but it may alternatively be a conventional KVM switch without a network connection.

FIG. 1 also illustrates a remote site including a remote IKVM switch 15 with a plurality of remote computers 18 connected to it. The remote IKVM switch 15 is connected to the network by a network connection. The remote IKVM switch 15 also has its own console module 16 connected to it. The console module 16 is shown in FIG. 1 as a combination console having both a connection to the IKVM switch 15 and a network connection, but it may also be a conventional console without a network connection.

In this disclosure, the term “local” refers to devices connected to each other by cables, which may be up to hundreds of feet long, while the term “remote” refers to devices connected to each other by a network, such as WAN, LAN, the Internet, etc. In the system of FIG. 1, the console 11, combination console module 12, KVM switch 13 and computers 14 are collectively referred to as the local site and the console 17, console module 16, IKVM switch 15 and computers 18 are collectively referred to as the remote site. In one embodiment, the network includes Internet, Intranet, Ethernet, Wide area network (WAN), Local area network (LAN) or wireless network.

According to embodiments of the present invention, the combination console module 12 enables the console 11 to act as a local console for the local KVM switch 13 to control the local computers 14, and act as a remote console for the remote IKVM switch 15 to control the remote computers 18. The keyboard/mouse signals from the local console 11 may be transmitted to the remote computer 18 via several alternative routes (in the expressions below, the symbol “→” represents the transmission direction of keyboard/mouse signals):

(1-1) Local keyboard/mouse→local combination console module→local IKVM→Network→remote IKVM→remote PC
(1-2) Local keyboard/mouse→local combination console module→local IKVM→Network→remote combination console module→remote IKVM→remote PC
(1-3) Local keyboard/mouse→local combination console module→Network→remote IKVM→remote PC
(1-4) Local keyboard/mouse→local combination console module→Network→remote combination console module→remote IKVM→remote PC

The video signals from the remote computer 18 may be transmitted to the display 11c of the local console 11 via several alternative routes:

(1-5) Remote PC→remote IKVM→remote combination console module→Network→local combination console module→local display
(1-6) Remote PC→remote IKVM→remote combination console module→Network→local IKVM→local combination console module→local display
(1-7) Remote PC→remote IKVM→Network→local combination console module→local display
(1-8) Remote PC→remote IKVM→Network→local IKVM→local combination console module→local display

Note that in routes (1-1), (1-2), (1-6) and (1-8), where the keyboard/mouse signals go through the local IKVM switch, a conventional IKVM switch needs to be modified in its software or firmware to support the signal transmission.

All of the above signal routes will be possible if both KVM switches 13 and 15 are IP-based switches and both console modules 12 and 16 are combination console modules with network connections. If not, some of the above signal routes will not be available. It can also be observed that a combination console module connected to a non-IP-based KVM switch can provide network access to the switch, effectively turning that switch into an IP-based switch. For example, if the KVM switch 15 is not IP-based (i.e. has no network connection of its own), but its local console 16 is a combination console with a network interface, then the local console 11 (or any client on the network) can access the remote computers 18 using signal routes (1-4) and (1-5) or using signal routes (1-2) and (1-6).

When several signal transmission routes are possible, the selection of routes may be done by a control center (not shown) by controlling or programming the respective KVM switches or combination console modules. The control center is typically a server or any network node that has access to the various devices (either directly or via the network). The control center may allow a user to request particular route.

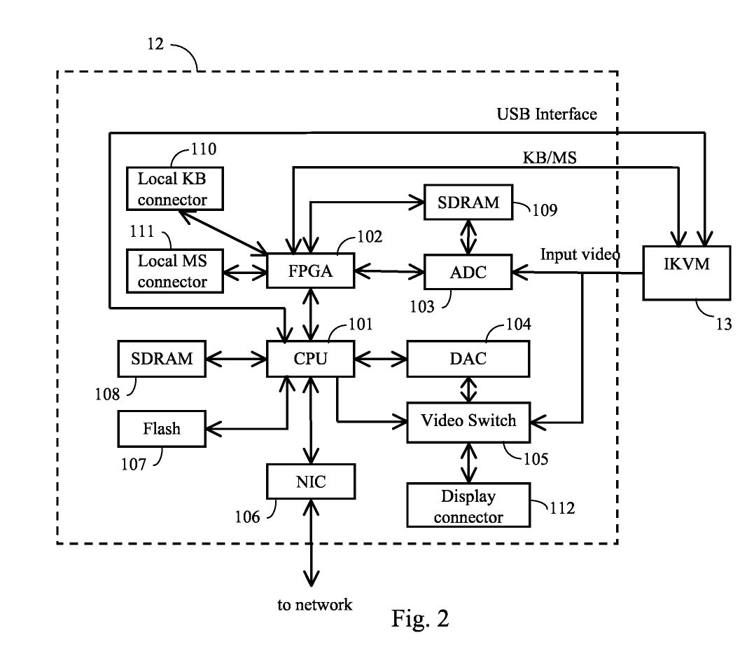

FIG. 2 illustrates the structure of a combination console module 12 according to an embodiment of the present invention. The combination console module 12 includes a CPU 101, an FPGA 102, an analog to digital converter (ADC) 103, a digital to analog converter (DAC) 104, a video switch 105, and a network interface device (NIC) 106. (The acronym NIC are used to refer to network interface device, network interface circuit, network interface controller, and network interface card, which are different names for the same component. In the present disclosure, the term “network interface device” is used for convenience.) It also includes various memories 107-109, and connectors 110-112 for the local keyboard, mouse and display. The connectors 110-112 may have any suitable physical form. The keyboard, mouse and display themselves may be separate physical devices plugged into the combination console module; alternatively, the keyboard, mouse, display and the combination console module may be integrated into a single physical unit, in which case components 110, 111 and 112 are actual keyboard, mouse and display devices. The combination console module 12 supports the following functions.

The console connected to the combination console module 12 can act as a local console for a local KVM switch 13 to control a local computer connected thereto (not shown in FIG. 2). In such a case (referred to as the local mode), the video signals received from the local computer via the local KVM switch 13 are sent to the display 112 via the video switch 105. The keyboard and mouse signals from the local keyboard connector 110 and the local mouse connector 111 are processed by the FPGA 102 and transmitted to the KVM switch 13. The console connected to the combination console 12 can also act as a remote console to control a remote computer via a remote KVM switch (not shown in FIG. 2). In such a case (referred to as the remote mode), the digital video signals from the remote computer via the network are received by the NIC 106, processed by the CPU 101 (e.g. decompressed), converted to analog video signals by the DAC 104, and sent to the display connector 112 via the video switch 105. The keyboard and mouse signals from the local keyboard connector 110 and the mouse connector 111 are processed by the FPGA 102 and the CPU 101, and transmitted by the NIC 106 over the network to the remote KVM switch. The video switch 105 is controlled by the CPU 101 so that either the input video signal from the KVM switch 13 or the video signal from the DAC 104 is provided to the display connector 112 depending on the operating mode.

Additionally, the combination console module 12 can act as an intermediary between the local KVM switch 13 and a remote client (remote console) that is accessing the KVM switch 13 over the network (the intermediary mode). Note that the combination console module 12 can act as an intermediary at the same time it is acting as a local or remote console; in other words, the remote client can still receive video signal from combination console while the combination console is accessing remote IKVM. In this situation, the video signals received from the local computer via the local KVM switch 13 are converted to digital signals by the ADC 103, processed by the FPGA 102 and/or CPU 101 (e.g. video sampling, compression), and transmitted to the remote client over the network. The keyboard and mouse signals received form the remote client over the network are processed by the CPU 101 and/or FPGA 102, and transmitted to the KVM switch 13. As mentioned earlier, by connecting such a combination console module 12 to the KVM switch 13, the KVM switch 13 becomes accessible over the network even if it does not have its own network connection. If the KVM switch 13 has its own network connection, the combination console module 12 can provide an additional network connection between the KVM switch 13 and the network, sharing the load of the network connection of the KVM switch 13.

It should be noted that the ADC 103 is not necessary for the combination console module 12 to perform its function as a local console for the local KVM switch 13 and as a remote console for a remote KVM switch. It is required when the combination console module 12 acts as an intermediary between the KVM switch 13 and a remote client.

In the structure shown in FIG. 2, the flash memory 107 and SDRAM 108 provides storage and memory for the CPU 101. The SDRAM 109 connected to the FPGA 102 is a buffer memory for the digital data generated by the ADC 103. The combination console module 12 may optionally include a USB interface connected to the IKVM switch 13. If the KVM 13 only supports a USB interface, the USB interface of the combination console module 12 can be used to communication with the KVM 13. Also, this USB interface can be used for other applications if the IKVM 13 support these applications, such as mass storage, audio, etc.

A user interface (UI) is implemented (either by the CPU 101 or by the KVM switch 13) to allow the user to select the operating mode. The implementation of such a UI is well within the capabilities of those familiar with the KVM and IKVM art. For example, a user may log in to the local IKVM via the local console, and the UI may show the local computers connected to the local IKVM and the remote computers connected to the remote IKVM, so that the user may select a local computer or a remote computer via the UI and then control the selected computer.

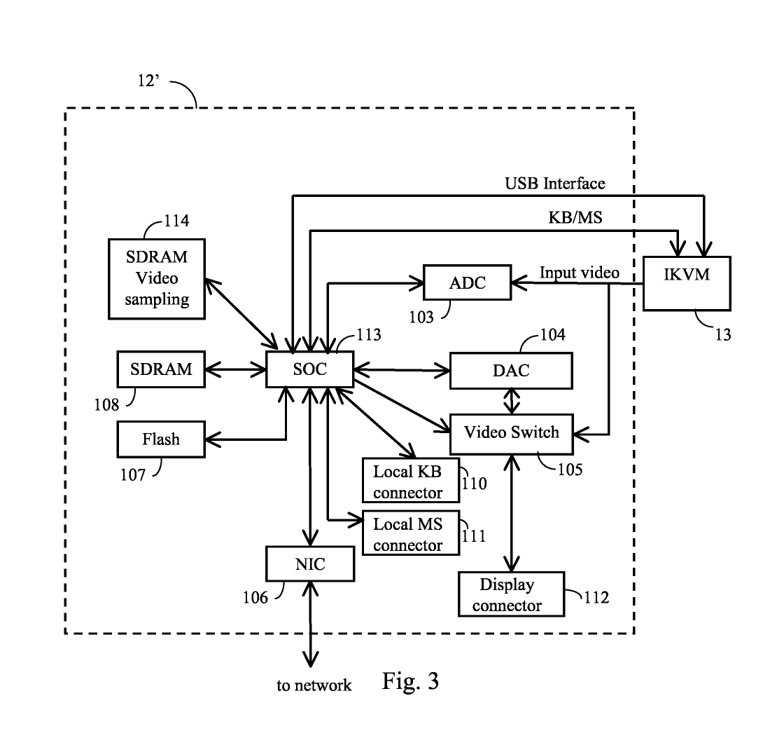

FIG. 3 illustrates another implementation of a combination console module. The structure of this combination module 12′ is similar to that shown in FIG. 2, except that the CPU 101 and the FPGA 102 are combined into a system on chip (SOC) device 113. Although not shown here, the DAC 104 can also be implemented as a part of the SOC 113. An SDRAM 114 provides a buffer memory for video sampling. The combination console module 12′ functions in similar ways as the combination console module 12 and detailed explanations are omitted here.

As seen from FIGS. 2 and 3, the specific implementations of the various components of the combination console are not critical, so long as the functionalities of the components are implemented. More generally, the CPU 101 and the FPGA 102 in FIG. 2 or the SOC 113 in FIG. 3 constitute a control section that performs various data processing and control functions.

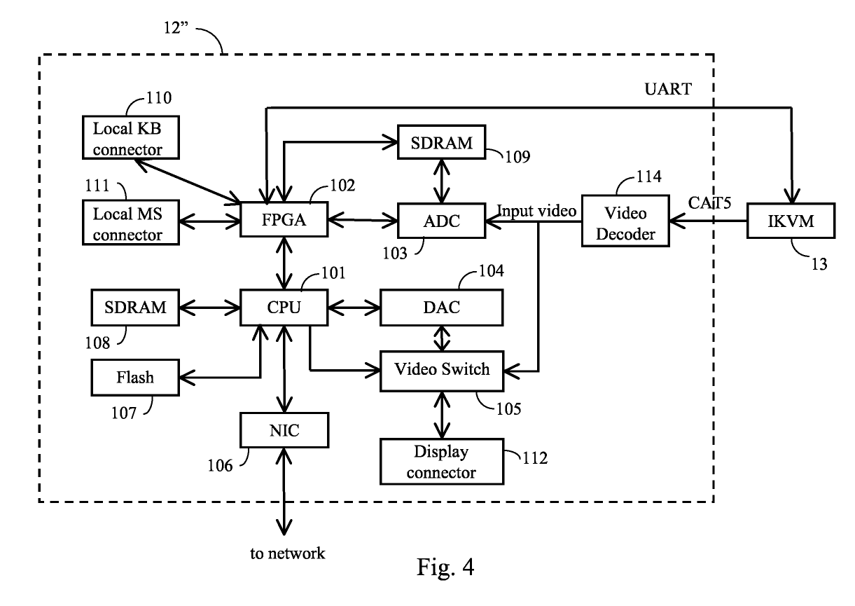

FIG. 4 illustrates another implementation of a combination console module. The structures of this combination module 12″ are similar to that shown in FIG. 2, except that the combination console module 12″ and the local KVM switch 13 are connected by a CAT 5 connection for transmitting video signals and a high speed UART connection for transmitting keyboard and mouse signals. The combination console module 12″ additionally includes a video decoder 114 to decode the video signals received from the KVM switch 13 on the CAT 5 connection.

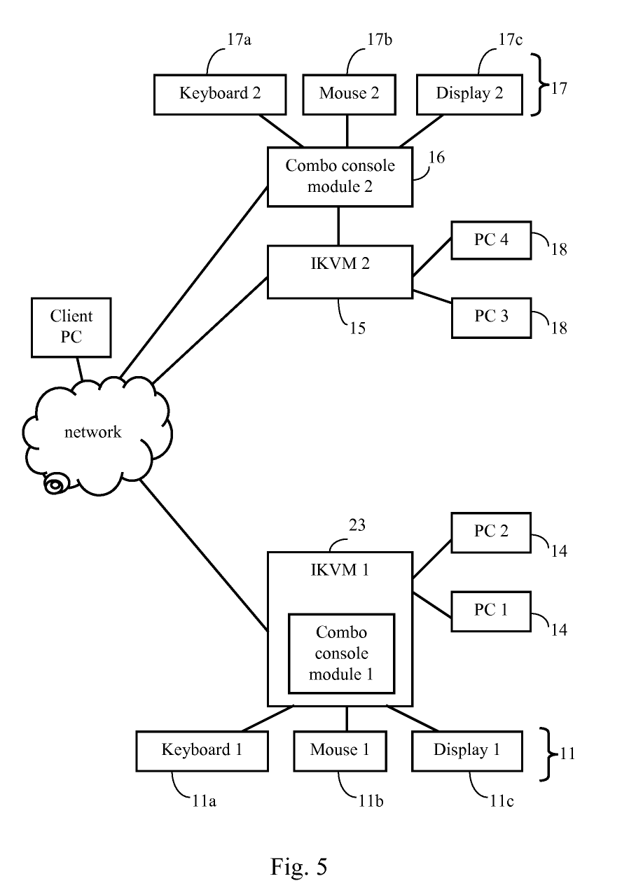

In a second configuration, shown in FIG. 5, the combination console module function is provided as a part of the local KVM switch. The overall system shown in FIG. 5 is similar to that shown in FIG. 1, except that the local KVM switch 13 and the stand-alone combination console module 12 in FIG. 1 are replaced by a modified IKVM switch 23 that has combination console module functionality. The local console 11 including the local keyboard 11a, mouse 11b and display 11c is connected to the IKVM switch 23 by cables. The combination console module functionality of the IKVM switch 23 enables the local console 11 to act as a remote console for the remote IKVM switch 15 to control the remote computers 18, in addition to acting as a local console for the local IKVM switch 23 to control the local computers 14. The keyboard/mouse signals from the local console 11 may be transmitted to the remote computer 18 via the following alternative routes:

(2-1) Local keyboard/mouse→local IKVM→Network→remote IKVM→remote PC
(2-2) Local keyboard/mouse→local IKVM→Network→remote combination console module→remote IKVM→remote PC

The video signals from the remote computer 18 may be transmitted to the display 11c of the local console 11 via the following alternative routes:

(2-3) Remote PC→remote IKVM→Network→local IKVM→local display
(2-4) Remote PC→remote IKVM→remote combination console module→Network→local IKVM→local display

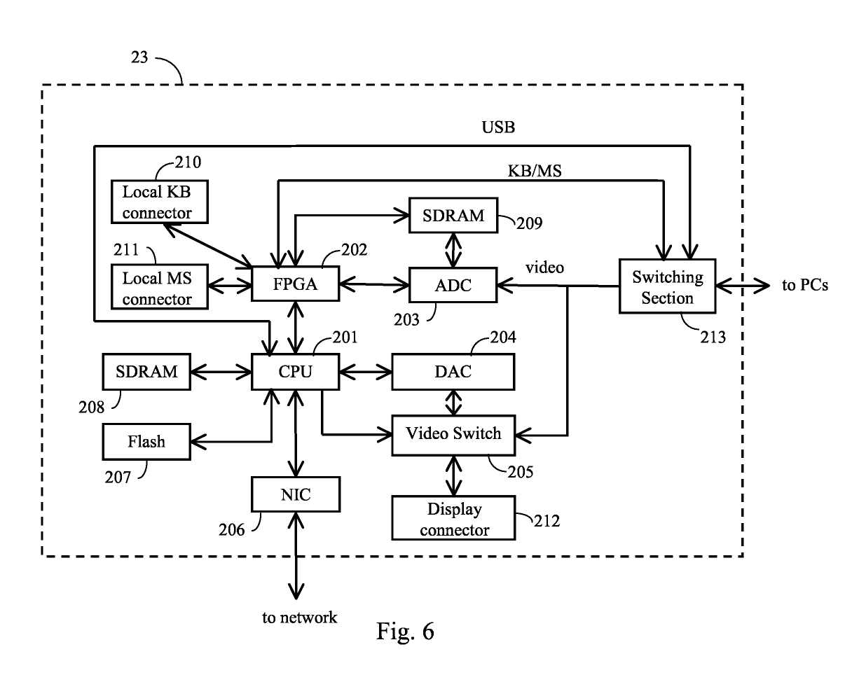

FIG. 6 illustrates the structure of a modified IKVM switch 23 that has combination console module functionality. The KVM switch 23 can be connected to one or more local consoles and multiple computers to allow each console to selectively access the computers. Components 201 to 212 are identical or similar to the corresponding components 101 to 112 of the combination console module 12 shown in FIG. 1 and perform the same respective functions. Depending on the number of local consoles supported by the KVM switch 23, there may be multiple sets of local keyboard, local mouse and local display connectors 210-212. The switching section of the KVM switch 23, schematically represented by 213, functions to switch signals between one or more consoles and multiple computers. The switching section 213 has one or more console signal ports for connecting to the FPGA 202 and the video switch 205 (only one is shown), and one or more computer signal ports for connecting to the computers (only one is shown). The switching section 213 may be implemented by any suitable structures as in a conventional KVM switch, such as crosspoint switches, etc., and may have its own controller. One pair of ADC 203 and DAC 204 is provided for each local console. The video switch 205 may use a matrix switch for switching video signals between the one or more consoles and the multiple computers. More than one CPUs 201 and FPGAs 202 may be provided to handle the processing needs, depending on the processing capacity and performance of each CPU 201 and FPGA 202.

The modified IKVM switch 23 supports the following functions with respect to each console connected thereto: The console can act as a local console to access local computers connected to the IKVM switch (local mode with respect to that console); and the console can act as a remote console to an IKVM switch on the network (remote mode with respect to that console). In addition, the IKVM switch 23 acts switch as an IP-based KVM switch to allow remote clients on the network to access local computers connected to it (remote client mode). The operations of the various components 201-212 in these three modes are identical or similar to the operations of the corresponding components in FIG. 2 described earlier and will not be repeated here.

In the modified IKVM switch 23 shown in FIG. 6, the DAC 204 is not present in a conventional IKVM switch. Because of the lack of a DAC, a conventional IKVM switch cannot provide video signals of a remote computer received by the NIC to the local display, and therefore the console connected to the KVM switch cannot act as a remote console of a remote computer. By adding the DAC 204, the local display will be able to receive video signals from a remote computer. The video switch 205 is present in a conventional IKVM that supports multiple local consoles, but it is now additionally connected to the DAC 204 and has the additional function of switching the video signals from the remote computer to the local display connector 212. If the conventional KVM switch is one that supports only one local console and does not have a video switch, the video switch 205 can be added to the conventional switch to form the modified IKVM switch 23. Components 201-203 and 206-213 are present in a conventional IKVM switch, although the programming of the CPU 201 and the FPGA 202 are modified as necessary to carry out additional functions.

If the ADC 203 is not present, the KVM switch 23 can still allow the console connected thereto to act as a local console to the KVM switch 23 or as a remote console to a remote IKVM. The ADC 203 is required in order for the KVM switch 23 to be an IP-based KVM and accessible by remote clients over the network.

The CPU 201 and FPGA 202 may be combined into a system on chip (SOC) device. The DAC 204 may also be implemented as a part of the SOC. The specific implementations of the various components are not critical, so long as the functionalities of the components are implemented.

In the combination console module 12, 12′, 12′ and 23 shown in FIGS. 2, 3, 4 and 6, respectively, the DAC 104 and 204 are necessary only when the display device is a conventional display device that receives conventional analog video signals. If the display device is one that uses a digital interface, such as one that uses a HDMI (High-Definition Multimedia Interface) or DVI (Digital Visual Interface) display port, then the DAC 104 or 204 is not necessary. Instead, it may be replaced by a digital video signal converter chip that converts the digital video signals received from the network into digital video signals of an appropriate format for the particular digital interface for the display. More generally, a video signal converter is provided between the CPU 101 or 201 (or the SOC 113) and the display connector 112 or 212 to convert the video signal into a format appropriate for the display device.

In this disclosure, the term “console” refers to a set of devices that collectively allows an operator to interact with a computer. A console includes input devices, typically a keyboard and (optionally) a mouse, and output devices, typically a display screen.

It will be apparent to those skilled in the art that various modification and variations can be made in the combination console module of the present invention without departing from the spirit or scope of the invention. Thus, it is intended that the present invention cover modifications and variations that come within the scope of the appended claims and their equivalents.

What is claimed is:

1. A control device for connecting to a console, the console including one or more input devices and a display device, the control device comprising:
a control section;
an input connection for connecting to the input devices of the console, the input connection being connected to the control section;
a video connection for connecting to the display device of the console;
a video signal converter connected between the control section and the video connection for converting a processed digital video signal from the control section to a display video signal for the display device;
a video switch connected to the video signal converter and connected to an input video signal, the video switch being controlled by the control section for providing either the input video signal or the display video signal to the video connection; and
a network interface device for connecting to a network,
wherein when the control device is in a local mode, the video switch switches the input video signal to the video connection, and the control section processes a first input device signal received from the console via the input connection to generated a processed input device signal, and
wherein when the control device is in a remote mode, the control section processes a digital video signal received from the network via the network interface device to generate the processed digital video signal, the video signal converter converts the processed digital video signal to the display video signal, the video switch switches the display video signal from the video signal converter to the video connection, and the control section processes the input device signal received from the console via the input connection and transmit it to the network via the network interface device.

2. The control device of claim 1, further comprising:
an analog to digital converter (ADC) for converting the input video signal to a converted digital video signal,
wherein when the console module is in an intermediary mode, the ADC converts the input video signal to the converted digital video signal, the control section processes the converted digital video signal and transmits it to the network via the network interface device, and the control section further processes a second input device signal received from the network via the network interface device to generated the processed input device signal.

3. The control device of claim 1, wherein the control device is a stand-alone device and is adapted to be connected to an external switching device by one or more cables.

4. The control device of claim 1, wherein the control device is adapted to be connected to the console by one or more cables.

5. The control device of claim 1, further comprising:
a switching section having at least one console signal port and one or more computer signal ports, the console signal port being connected to the control section, the switching section switching signals between the console signal port and the computer signal ports,
wherein the when the control device is in the local mode, the switching section provides the input video signal for the video switch, and the control section transmits the processed input device signal to the switching section.

6. The control device of claim 5, further comprising:
an analog to digital converter (ADC) connected to the switching section for converting the input video signal from the switching section to a converted digital video signal,
wherein when the control device is in a remote client mode, the ADC converts the input video signal from the switching section to the converted digital video signal, the control section processes the converted digital video signal and transmits it to the network via the network interface device, and the control section further processes a second input device signal received from the network via the network interface device and transmits it to the switching section.

7. The control device of claim 5, wherein the video signal converter is a digital to analog converter.

8. The control device of claim 1, wherein the video signal converter is a digital to analog converter.

9. A method implemented in a control device, the control device adapted to be connected to a console and to a network, the method comprising:
(a) selecting a local mode or a remote mode;
when in the local mode,
(b1) processing a local input video signal and transmitting the processed video signal to the console; and
(b2) processing a first input device signal received from the console and generating a processed input device signal; and
when in the remote mode,
(c1) processing a digital video signal received from the network and transmitting the processed video signals to the console; and
(c2) processing the first input device signal received from the console and transmitting the processed input device signal to the network.

10. The method of claim 9, further comprising:
(d) selecting an intermediary mode;
when in the intermediary mode,
(e1) processing the local input video signal and transmitting the processed video signals to the network; and
(e2) processing a second input device signal received from the network and generating a processed input device signal.

11. The method of claim 9, wherein the control device is connected to one or more computers,
wherein in step (b 1) the local input video signal is received from a selected computer, and
wherein step (b2) further comprises transmitting the processed input device signal to the selected computer.

12. The method of claim 11, further comprising:
(d) selecting a remote client mode;
when in the remote client mode,
(e1) processing the local input video signal received from the selected computer and transmitting the processed video signal to the network; and
(e2) processing a second input device signal received from the network and transmitting the processed input device signal to the selected computer.

13. A computer management system, comprising:
a first keyboard-video-mouse (KVM) switch;
at least one first computer connected to the first KVM switch;
a second KVM switch;
at least one second computer connected to the second KVM switch;
a first console module connected to the first KVM switch, the first console module being connected to the second KVM switch via a network; and
a console connected to the first console module,
wherein the first console module allows the console to selectively control the first computer or the second computer.

14. The system of claim 13, wherein the first console module is further connected to the second KVM switch via the first KVM switch and the network.

15. The system of claim 13, further comprising a second console module connected to the second KVM switch, wherein the first console module is connected to the second KVM switch via the first KVM switch, the network and the second console module.

16. The system of claim 13, further comprising a second console module connected to the second KVM switch, wherein the first console module is connected to the second KVM switch via the network and the second console module.

17. The system of claim 13, further comprising:
a second console module connected to the second KVM switch and the network;
a second console connected to the second console module,
wherein the second console is connected to the first computer via the second console module, the network, the first console module and the first KVM switch.

18. The computer management system of claim 13, wherein the console includes one or more input devices and a display device, wherein the first console module comprises:
a control section;
an input connection for connecting to the input devices of the console, the input connection being connected to the control section;
a video connection for connecting to the display device of the console;
a digital to analog converter (DAC) connected to the control section for converting digital video signals to analog video signals;
a video switch connected to the DAC and connected to input video signals from the first KVM switch, the video switch being controlled by the control section for providing either the input video signals from the first KVM switch or the analog video signals from the DAC to the video connection; and
a network interface device for connecting to the network.

19. The system of claim 18,
wherein when the first console module is in a local mode, the video switch switches the input video signals from the first KVM switch to the video connection, and the control section processes input signals received from the console via the input connection and transmit them to the first KVM switch, and
wherein when the first console module is in a remote mode, the control section processes digital video signals received from the network via the network interface device, the DAC converts the processed digital video signal to analog video signals, the video switch switches the analog video signals from the DAC to the video connection, and the control section processes input signals received from the console via the input connection and transmit them to the network via the network interface device.

20. The system of claim 18, wherein the first console module further comprises:
an analog to digital converter (ADC) for converting the input video signals from the first KVM switch to digital video signals,
wherein when the first console module is in an intermediary mode, the ADC converts the input video signals from the first KVM switch to digital video signals, the control section processes the digital video signals and transmits them to the network via the network interface device, and the control section further processes input signals received from the network via the network interface device and transmits them to the first KVM switch.
